(19) United States
(12) Patent Application Publication
(10) Pub. No.: US 2022/0092948 A1
(43) Pub. Date: Mar. 24, 2022

(54) MONITORING POINT OF SALE PERIPHERAL DEVICES

(71) Applicant: HEWLETT-PACKARD DEVELOPMENT COMPANY, L.P., Spring, TX (US)

(72) Inventors: Binh Truong, 10300 Energy Drive, TX (US); Pun Yi Lee, Spring, TX (US)

(73) Assignee: HEWLETT-PACKARD DEVELOPMENT COMPANY, L.P., Spring, TX (US)

(21) Appl. No.: 17/414,418

(22) PCT Filed: Dec. 17, 2018
(86) PCT No.: PCT/US2018/066023

§ 371 Date: Jun. 16, 2021

(51) Int. Cl. G07G 1/00; G06Q 20/20; G07G 1/12

(52) U.S. Cl. CPC G07G 1/0009; G07G 1/12; G06Q 20/202

(57) ABSTRACT

A system includes a machine readable storage medium storing instructions and a processor to execute the instructions. The processor executes the instructions to monitor software calls between a point of sale application and a sharable point of sale peripheral device, wherein each software call defines a type of access to the sharable point of sale peripheral device. The processor executes the instructions to collect management data for the sharable point of sale peripheral device based on the monitored software calls. The processor executes the instructions to store the collected management data to create a record of the usage of the sharable point of sale peripheral device.

### BACKGROUND

The Unified Point of Service (UnifiedPOS) standard is an architectural specification for the application interfaces of point-of-service devices used in retail environments. The standard is operating system independent and language neutral. The standard defines an architecture for interfacing applications to retail devices and defines a set of retail device behaviors sufficient to support a range of POS solutions.

### BRIEF DESCRIPTION OF THE DRAWINGS

FIGS. 1A-1B are block diagrams illustrating one example of a processing system for managing a point of sale peripheral device.

FIG. 2 is a block diagram illustrating one example of a point of sale architecture.

FIGS. 3A-3C are block diagrams illustrating one example of a processing system for managing a cash drawer device.

FIGS. 4A-4B are flow diagrams illustrating one example of a method for managing a point of sale peripheral device.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Usage data and/or manageability data have been lacking for retail sharable device classes, such as cash drawer devices, gate devices, hard total devices, keylock devices, motion sensor devices, point of sale power devices, and tone indicator devices, since in a retail environment these devices may operate mechanically and may not include any firmware to store statistical data. For retail sharable device classes that may include firmware, the firmware may not support manageability data, such as the capability to monitor events, generate alert notifications, store usage data, etc.

Accordingly, disclosed herein are systems and methods to manage retail sharable device classes so that devices that do not have firmware, or do not have firmware supporting manageability data, have the capability to support manageability data. The systems and methods disclosed herein utilize the control layer of the UnifiedPOS specification to filter and convert data for manageability purposes.

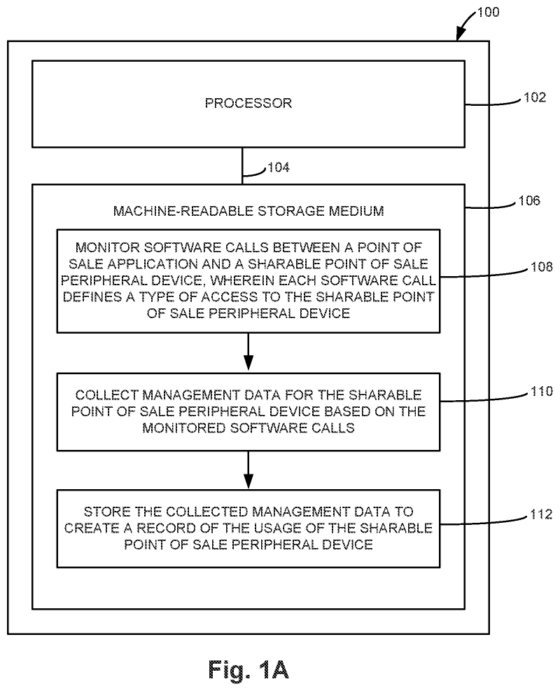

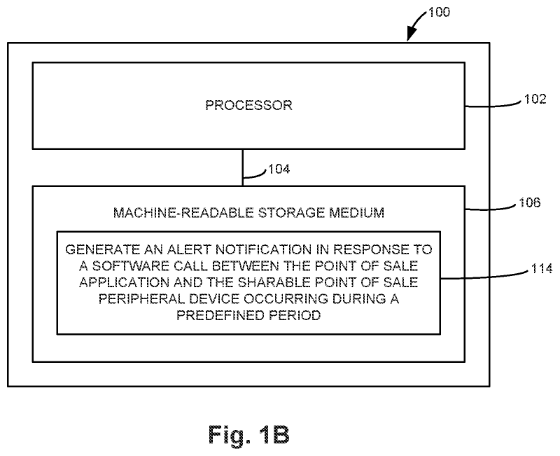

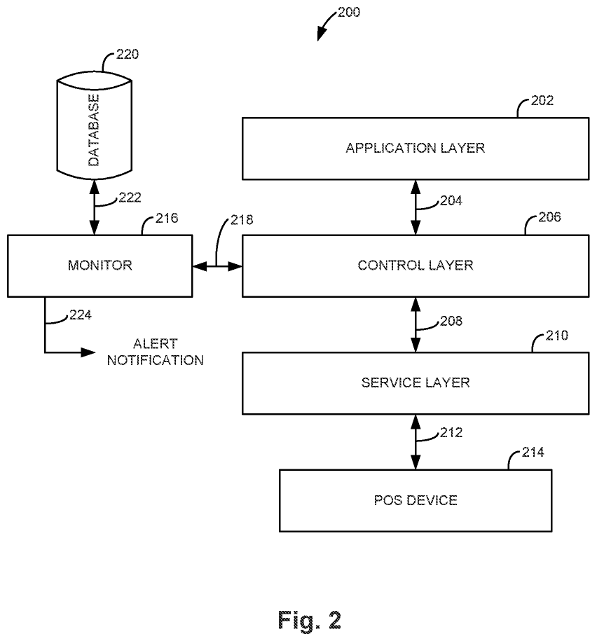

FIGS. 1A-1B are block diagrams illustrating one example of a processing system 100 for managing a point of sale peripheral device. In one example, system 100 may be part of monitor 216, which will be further described below with reference to FIG. 2. System 100 includes a processor 102 and a machine-readable storage medium 106. Processor 102 is communicatively coupled to machine-readable storage medium 106 through a communication path 104. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 102 includes one (i.e., a single) central processing unit (CPU) or microprocessor or more than one (i.e., multiple) CPU or microprocessor, and/or other suitable hardware devices for retrieval and execution of instructions stored in machine-readable storage medium 106. Processor 102 may fetch, decode, and execute instructions 108-114 to manage a point of sale peripheral device.

Processor 102 may fetch, decode, and execute instructions 108 to monitor software calls between a point of sale application and a sharable point of sale peripheral device, wherein each software call defines a type of access to the sharable point of sale peripheral device. In one example, the sharable point of sale peripheral device may include a cash drawer device, a gate device, a hard total device, a keylock device, a motion sensor device, a point of sale power device, or a tone indicator device. Processor 102 may fetch, decode, and execute instructions 110 to collect management data for the sharable point of sale peripheral device based on the monitored software calls. In one example, the management data may include a count of the number of software calls for each type of access to the sharable point of sale peripheral device. In another example, the management data may include the day and time of each software call and the type of access to the sharable point of sale peripheral device. Processor 102 may fetch, decode, and execute instructions 112 to store the collected management data to create a record of the usage of the sharable point of sale peripheral device.

As illustrated in FIG. 1B, processor 102 may fetch, decode, and execute further instructions 114 to generate an alert notification in response to a software call between the point of sale application and the sharable point of sale peripheral device occurring during a predefined period.

As an alternative or in addition to retrieving and executing instructions, processor 102 may include one (i.e., a single) electronic circuit or more than one (i.e., multiple) electronic circuit comprising a number of electronic components for performing the functionality of one of the instructions or more than one of the instructions in machine-readable storage medium 106. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 106 is a non-transitory storage medium and may be any suitable electronic, magnetic, optical, or other physical storage device that stores executable instructions. Thus, machine-readable storage medium 106 may be, for example, random access memory (RAM), an electrically-erasable programmable read-only memory (EEPROM), a storage drive, an optical disc, and the like. Machine-readable storage medium 106 may be disposed within system 100, as illustrated in FIGS. 1A-1B. In this case, the executable instructions may be installed on system 100. Alternatively, machine-readable storage medium 106 may be a portable, external, or remote storage medium that allows system 100 to download the instructions from the portable/external/remote storage medium. In this case, the executable instructions may be part of an installation package.

FIG. 2 is a block diagram illustrating one example of a point of sale architecture 200. Point of sale (or point of service) architecture 200 includes an application layer 202, a control layer 206, a service layer 210, a point of sale (POS) device 214, a monitor 216, and a database 220. Application layer 202 is communicatively coupled to control layer 206 through a communication path 204. Control layer 206 is communicatively coupled to service layer 210 through a communication path 208 and to monitor 216 through a communication path 218. Service layer 210 is communicatively coupled to POS device 214 through a communication path 212. Monitor 216 is communicatively coupled to database 220 through a communication path 222. Monitor 216 may output alert notifications through a communication path 224.

Application layer 202 provides an application that interacts with one or multiple POS devices. Application layer 202 may manipulate physical devices (e.g., a hardware unit or peripheral device) by calling platform specific application program interfaces (APIs) that conform to the UnifiedPOS standard. Some physical devices may support more than one device category. For example, some POS printers may include a cash drawer kickout, and some bar code scanners may include an integrated scale. However, with UnifiedPOS, an application treats each of these device categories as if it were an independent physical device.

Control layer 206 provides an interface between the application layer 202 and the service layer 210 and provides controls for device categories. Control layer 206 does not contain graphical components and is therefore invisible at runtime. Control layer 206 may be designed so that all implementations of a device category's control will be compatible. Therefore, control layer 206 may be developed independently of the service layer 210 for the same device category.

Service layer 210 provides an interface between the control layer 206 and the POS device 214. Service layer 210 is used by the control layer 206 to implement UnifiedPOS-prescribed functionality for POS device 214. Service layer 210 may also call special event methods provided by the control layer 206 to deliver events to the application layer 202. A set of service classes may be implemented to support physical devices with multiple device categories.

POS device 214 may include a cash drawer device, a gate device, a hard total device, a keylock device, a motion sensor device, a point of sale power device, a tone indicator device, or another suitable retail sharable device. A cash drawer device supports a command to “open” the cash drawer. In addition, a cash drawer device may support drawer status reporting of such a nature that the service layer 210 can determine whether a particular drawer is open or closed.

A gate device may include, for example, a kiosk front door that may be opened by an application for servicing, a self-checkout door that may be opened by an application for servicing, or an exit gate in a kiosk or a self-checkout environment where a customer scans a barcode printed on a receipt to open the gate. A gate control device supports a command to “open” the gate. In addition, a gate control device may support status reporting of such a nature that the service layer 210 can determine whether the gate is opened or closed.

A hard total device supports at least one totals file with the name “ ” (the empty string) in an area of totals memory. Each totals file is read and written as if it were a sequence of byte data. A hard total device creates each totals file with a fixed size and may be deleted, initialized, and claimed for exclusive use. A hard total device may support additional named totals files. They share some characteristics of a file system with only a root directory level. In addition, each totals file may also be renamed. A hard total device may support transactions, with begin and commit operations, plus rollback. A hard total device may also support advanced error detection. This detection may be implemented through hardware or software.

A keylock device may support at least three keylock positions and reporting of keylock position changes, either by hardware or software detection. A keylock device may also support an electronic keylock. A motion sensor device may support the detection of a person present at a POS device and reporting of motion detection changes, either by hardware or software detection.

A point of sale power device may support a command to “shut down” the system, a command to restart the system, a command to “suspend” the system, and a command to have the system go to standby. A point of sale power device may also support accessing a power handling mechanism of the underlying operating system and hardware. A point of sale power device may inform the application if a power fail situation has occurred, inform the application about battery level, inform the application if an uninterruptable power supply (UPS) charge state has changed, inform the application about high CPU temperature, inform the application about stopped CPU fan, and inform the application if an operating system dependent enforced shutdown mechanism is processed. In addition, a point of sale power device may allow the application, after saving application data locally or transferring application data to a server, to shut down the POS terminal and inform the application about an initiated shutdown.

A tone indicator device sounds a system speaker or another hardware device. A tone indicator device may sound a two-tone indicator or multiple tone “melodies”, providing simple pitch and volume control. In addition, a tone indicator device may provide a synchronous one-shot indicator, similar to an operating system's beep function.

Monitor 216 monitors software calls between the application layer 202 and the POS device 214 at the control layer 206. Monitor 216 may intercept commands, reports, events, data, etc., as described above between application layer 202 and POS device 214. Monitor 216 may, for example, monitor day to day activities of retail sharable device classes, determine the time and day when a software call is made to access a device, determine the time and day when a user physically accesses a device, and obtain device statistical data. The device statistical data may include, for example, determining the power hour count when a cash drawer device is being used or determining a total open count, a software driven open count, a key or manual access open count, etc., for a cash drawer device.

Monitor 216 may generate an alert notification in response to a count exceeding a predetermined count threshold or in response to suspicious activity. For example, an alert notification may be generated when a cash drawer device has an open status between certain hours or when a cash drawer device has an open status still remaining after a certain period. Monitor 216 may also prevent access or lock down devices between predefined times.

Monitor 216 may store the collected data to database 220. The data stored in database 220 may create a record of the usage of a POS device 214. The data stored in database 220 may be used for a variety of purposes, such as generating alert notifications, accounting, monitoring users, determining maintenance schedules for POS devices, estimating end of life of POS devices, identifying security risks, etc. In one example, database 220 may be at a remote location from monitor 216 and communication path 222 may include a local area network (LAN), a wide area network (WAN), the Internet, and/or another suitable communication path.

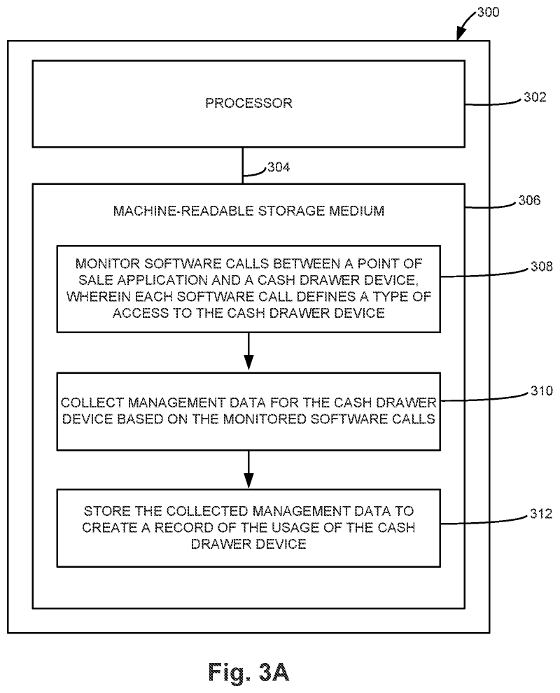

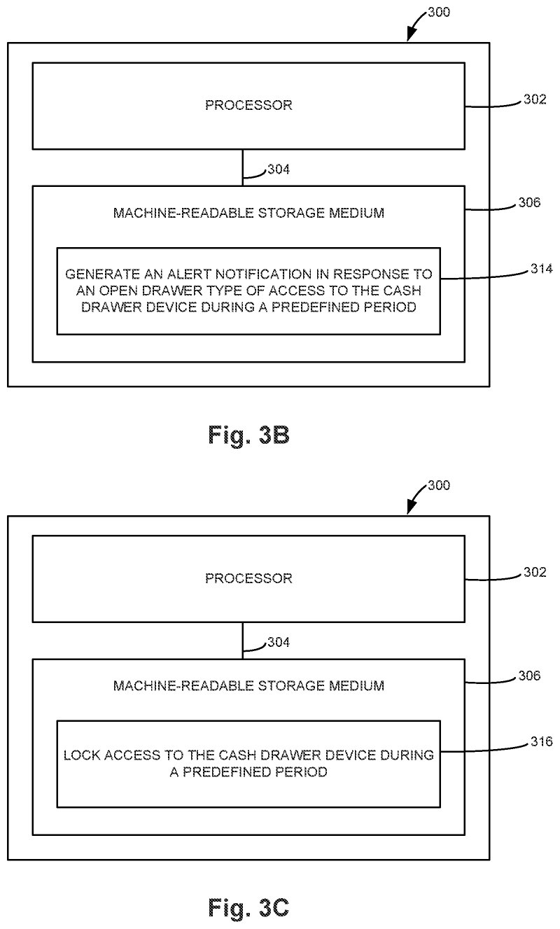

FIGS. 3A-3C are block diagrams illustrating one example of a processing system 300 for managing a cash drawer device. In one example, system 300 may be part of monitor 216 previously described and illustrated with reference to FIG. 2. System 300 includes a processor 302 and a machine-readable storage medium 306. Processor 302 is communicatively coupled to machine-readable storage medium 306 through a communication path 304. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 302 includes one (i.e., a single) central processing unit (CPU) or microprocessor or more than one (i.e., multiple) CPU or microprocessor, and/or other suitable hardware devices for retrieval and execution of instructions stored in machine-readable storage medium 306. Processor 302 may fetch, decode, and execute instructions 308-316 to manage a cash drawer device.

Processor 302 may fetch, decode, and execute instructions 308 to monitor software calls between a point of sale application and a cash drawer device, wherein each software call defines a type of access to the cash drawer device. Processor 302 may fetch, decode, and execute instructions 310 to collect management data for the cash drawer device based on the monitored software calls. In one example, the management data may include a count of the number of open drawer type of accesses to the cash drawer device. In another example, the management data may include the day and time of each software call and the type of access to the cash drawer device. Processor 302 may fetch, decode, and execute instructions 312 to store the collected management data to create a record of the usage of the cash drawer device.

As illustrated in FIG. 3B, processor 302 may fetch, decode, and execute further instructions 314 to generate an alert notification in response to an open drawer type of access to the cash drawer device during a predefined period. As illustrated in FIG. 3C, processor 302 may fetch, decode, and execute further instructions 316 to lock access to the cash drawer device during a predefined period.

As an alternative or in addition to retrieving and executing instructions, processor 302 may include one (i.e., a single) electronic circuit or more than one (i.e., multiple) electronic circuit comprising a number of electronic components for performing the functionality of one of the instructions or more than one of the instructions in machine-readable storage medium 306. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 306 is a non-transitory storage medium and may be any suitable electronic, magnetic, optical, or other physical storage device that stores executable instructions. Thus, machine-readable storage medium 306 may be, for example, RAM, EEPROM, a storage drive, an optical disc, and the like. Machine-readable storage medium 306 may be disposed within system 300, as illustrated in FIGS. 3A-3C. In this case, the executable instructions may be installed on system 300. Alternatively, machine-readable storage medium 306 may be a portable, external, or remote storage medium that allows system 300 to download the instructions from the portable/external/remote storage medium. In this case, the executable instructions may be part of an installation package.

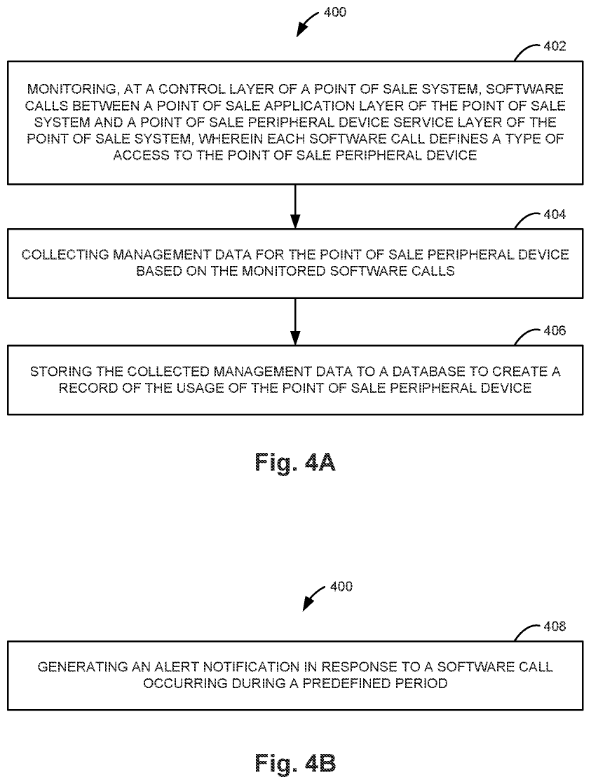

FIGS. 4A-4B are flow diagrams illustrating one example of a method 400 for managing a point of sale peripheral device. In one example, method 400 may be implemented by monitor 216 previously described and illustrated with reference to FIG. 2. As illustrated in FIG. 4A at 402, method 400 includes monitoring, at a control layer of a point of sale system, software calls between a point of sale application layer of the point of sale system and a point of sale peripheral device service layer of the point of sale system, wherein each software call defines a type of access to the point of sale peripheral device. In one example, the point of sale peripheral device may include a sharable point of sale peripheral device. At 404, method 400 includes collecting management data for the point of sale peripheral device based on the monitored software calls. In one example, collecting the management data may include counting the number of software calls for each type of access to the point of sale peripheral device. In another example, collecting the management data may include determining the day and time of each software call and the type of access to the point of sale peripheral device. At 406, method 400 includes storing the collected management data to a database to create a record of the usage of the point of sale peripheral device. As illustrated in FIG. 4B at 408, method 400 may further include generating an alert notification in response to a software call occurring during a predefined period.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a machine readable storage medium storing instructions; and
a processor to execute the instructions to:
monitor software calls between a point of sale application and a sharable point of sale peripheral device, wherein each software call defines a type of access to the sharable point of sale peripheral device;
collect management data for the sharable point of sale peripheral device based on the monitored software calls; and
store the collected management data to create a record of the usage of the sharable point of sale peripheral device.

2. The system of claim 1, wherein the processor is to execute the instructions to further:
generate an alert notification in response to a software call between the point of sale application and the sharable point of sale peripheral device occurring during a predefined period.

3. The system of claim 1, wherein the management data comprises a count of the number of software calls for each type of access to the sharable point of sale peripheral device.

4. The system of claim 1, wherein the management data comprises the day and time of each software call and the type of access to the sharable point of sale peripheral device.

5. The system of claim 1, wherein the sharable point of sale peripheral device comprises a cash drawer device, a gate device, a hard total device, a keylock device, a motion sensor device, a point of sale power device, or a tone indicator device.

6. A system comprising:
a machine readable storage medium storing instructions; and
a processor to execute the instructions to:
monitor software calls between a point of sale application and a cash drawer device, wherein each software call defines a type of access to the cash drawer device;
collect management data for the cash drawer device based on the monitored software calls; and
store the collected management data to create a record of the usage of the cash drawer device.

7. The system of claim 6, wherein the processor is to execute the instructions to further:
generate an alert notification in response to an open drawer type of access to the cash drawer device during a predefined period.

8. The system of claim 6, wherein the management data comprises a count of the number of open drawer type of accesses to the cash drawer device.

9. The system of claim 6, wherein the management data comprises the day and time of each software call and the type of access to the cash drawer device.

10. The system of claim 6, wherein the processor is to execute the instructions to further:
lock access to the cash drawer device during a predefined period.

11. A method for managing a point of sale peripheral device, the method comprising:
monitoring, at a control layer of a point of sale system, software calls between a point of sale application layer of the point of sale system and a point of sale peripheral device service layer of the point of sale system, wherein each software call defines a type of access to the point of sale peripheral device;
collecting management data for the point of sale peripheral device based on the monitored software calls; and
storing the collected management data to a database to create a record of the usage of the point of sale peripheral device.

12. The method of claim 11, further comprising:
generating an alert notification in response to a software call occurring during a predefined period.

13. The method of claim 11, wherein collecting the management data comprises counting the number of software calls for each type of access to the point of sale peripheral device.

14. The method of claim 11, wherein collecting the management data comprises determining the day and time of each software call and the type of access to the point of sale peripheral device.

15. The method of claim 11, wherein the point of sale peripheral device comprises a sharable point of sale peripheral device.
